(19) United States
(12) Patent Application Publication
(10) Pub. No.: US 2022/0360289 A1
(43) Pub. Date: Nov. 10, 2022

(54) Barcode Scanner Protective Covering

(71) Applicant: Deon Taylor, Stamford, CT (US)

(72) Inventor: Deon Taylor, Stamford, CT (US)

(21) Appl. No.: 17/313,774

(22) Filed: May 6, 2021

(51) Int. Cl. H04B 1/3888; A45C 13/00; A45C 13/10

(52) U.S. Cl. CPC H04B 1/3888; A45C 13/002; A45C 13/10; A45C 2013/1015

(57) ABSTRACT

A protective covering for barcode scanners.

### TECHNICAL FIELD

This application relates generally to protective cases, more particularly, to a protective covering for barcode scanners.

### BACKGROUND

It is well known that the healthcare field uses handheld, portable devices such as barcode scanners. These barcode scanners are used to scan patient identification bracelets and medications to prevent any medication and patient identification errors. However, since the start of the covid-19 pandemic, concerns about contamination of inanimate devices such as the barcode scanner have been at an all-time high.

The barcode scanner goes from patient to patient to scan their identification bracelets and medications; thus, if not cleaned properly, it can cause diseases such as COVID-19, C.Diff, MRSA and VRE.

Thus, there is a need to safely use barcode scanners, especially in the healthcare setting, so as to decrease or altogether prevent cross-contamination and therefore life-threatening conditions. Such a need is met by the barcode scanner protective covering, which is loosely fitting, disposable, biodegradable and water resistant.

### SUMMARY

In accordance with the present invention, the above and other problems are solved by providing a protective covering for the barcode scanner. The covering will be one size fits all so that it will fit barcode scanners of different sizes. Certain embodiments of the covering are white, pale yellow, or transparent in color. The covering is disposable so that it is a one-time use, which increases safety and decreases risk of contamination. The covering is made of biodegradable and water-resistant material; it will also have a type of material at the laser beam section of the barcode scanner that allows the laser beam to easily pass through without interference or interruption.

The covering will be sold in storage boxes that are easy to dispense, similar to a box of gloves. The storage boxes will house many coverings, comprising about 20-30 coverings.

One embodiment of the covering will be one piece. The handle of the barcode scanner will be placed into the covering first, similar to placing into a bag or pocket. As the covering gets to the top or head portion of the barcode scanner, it will be flipped over the top of the head of the barcode and closed shut, either by thin straps of Velcro or through the use of snap buttons. Other features and aspects will be apparent from the following detailed description, the drawings, and the claims.

Another embodiment of the covering will be two-piece. Similar to the one-piece, the handle of the barcode will be placed in the covering first, in the bottom part of the covering, and then the top part of the covering will be placed over the head of the barcode scanner. Either the top or bottom portion of the covering will have a drawstring on it and the portion without the drawstring will have two openings so that the drawstring can loop back through either the top or bottom and seal in place. Other features and aspects will be apparent from the following detailed description, the drawings, and the claims.

### BRIEF DESCRIPTION OF THE DRAWINGS

FIGS. 1-3 illustrate perspective views of one potential embodiment of a protective covering for barcode scanners, according to the present invention.

### DETAILED DESCRIPTION

The following detailed description is provided to assist the reader in gaining a comprehensive understanding of the products and/or systems provided herein. However, various changes, modifications, and equivalents of the products and/or systems described herein will be apparent to an ordinary skilled artisan.

The invention is directed to a protective covering for barcode scanners. The covering is made of biodegradable and water-resistant material. The covering is also made of a material at the laser beam section of the barcode scanner that allows the laser beam to easily pass through without interference or interruption. The covering is disposable, making it a one-time use. Certain embodiments of the covering are white, pale yellow, or transparent in color. The covering will be sold in storage boxes that are easy to dispense, similar to a box of gloves. The storage boxes will house many coverings, comprising about 20-30 coverings.

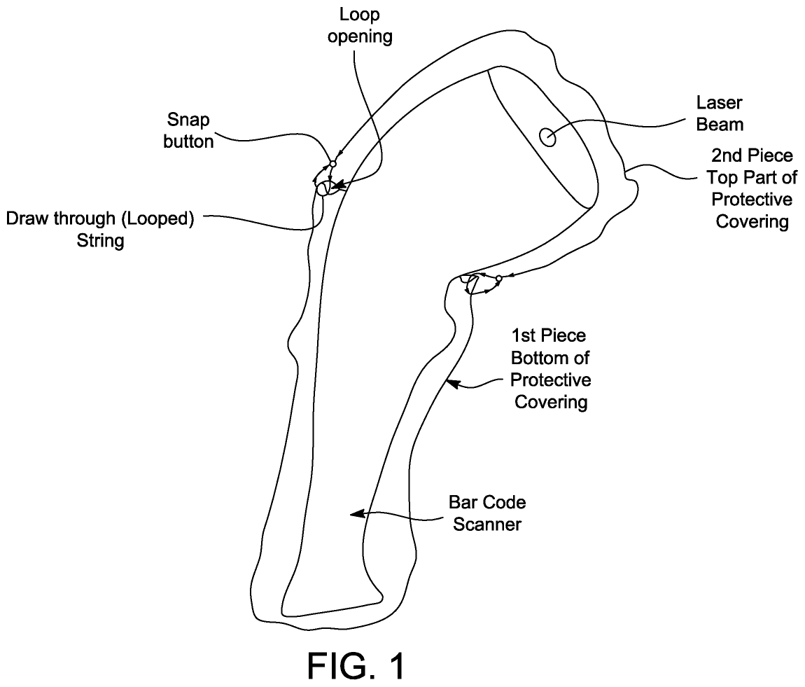

FIG. 1 shows a perspective view of an embodiment of a protective covering for a barcode scanner. The barcode scanner is upright with a two-piece protective covering including a snap button for closure and a looped string for the connecting the two-pieces.

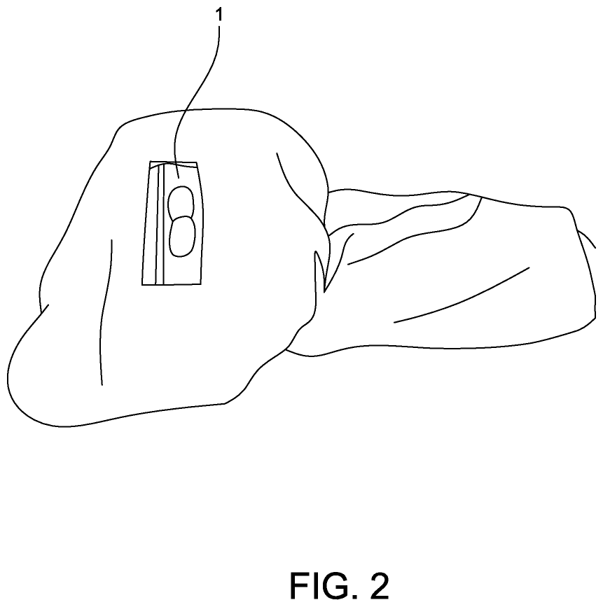

FIG. 2 shows a perspective view of an embodiment of a protective covering for a barcode scanner. The barcode scanner is loosely covered with the covering. The laser beam section of the barcode scanner 1 has a type of material that allows the laser beam to easily pass through without inference or interruption.

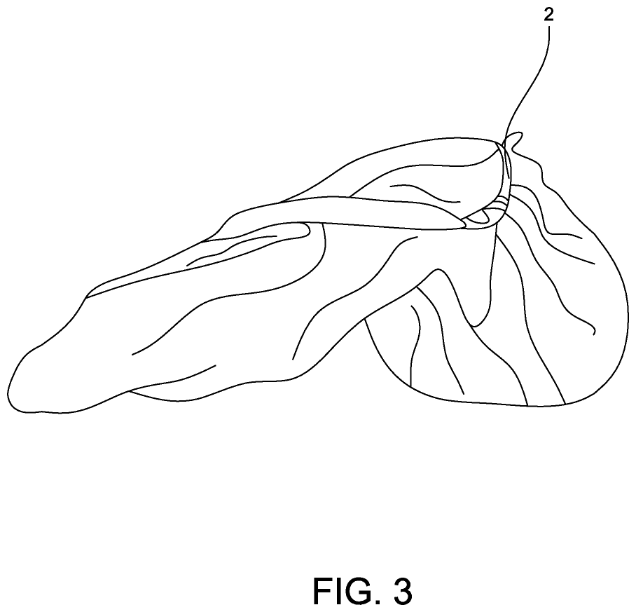

FIG. 3 shows a perspective view of an embodiment of a protective covering for a barcode scanner. The barcode scanner is loosely covered with the covering. The drawstring 2 is used for the closure of the covering.

I claim:

1. A protective cover for a barcode scanner comprising:
a body portion for receiving the barcode scanner and an access opening allowing the barcode scanner to pass therethrough, the body portion being formed of a flexible material and capable of loosely fitting onto the barcode scanner; and a closure for sealing the access opening on the body portion; wherein the protective cover case is capable of sealing the enclosed barcode scanner after the closure seals the access opening on the body portion.

2. A protective cover for a barcode scanner comprising:
a body portion for receiving the barcode scanner and an access opening allowing the handle of the barcode scanner to pass therethrough, the body portion being formed of a flexible material and capable of loosely fitting onto the handle of the barcode scanner; an upper portion for covering the head of the barcode scanner and an access opening allowing the head of the barcode scanner to pass therethrough; and a closure for sealing the access opening on the body portion and upper portion; wherein the protective cover case is capable of sealing the enclosed barcode scanner after the closure seals the access opening on the body portion and upper portion.

3. The protective covering of claim 1, wherein the body portion comprises a biodegradable and water resistant material.

4. The protective covering of claim 2, wherein the body portion comprises a biodegradable and water resistant material.

5. The protective covering of claim 2, wherein the upper portion comprises a biodegradable and water resistant material.

6. The protective covering of claim 1, wherein the closure seals by use of Velcro.

7. The protective covering of claim 2, wherein the body portion comprises a biodegradable and water resistant material.

8. The protective covering of claim 1, wherein the closure seals via buttons snapping shut.

9. The protective covering of claim 2, wherein the body portion comprises a biodegradable and water resistant material.

10. The protective covering of claim 1, wherein the closure seals via drawstrings.

11. The protective covering of claim 2, wherein the closure seals via drawstrings.
